(19) United States
(12) Patent Application Publication
(10) Pub. No.: US 2020/0011380 A1
(43) Pub. Date: Jan. 9, 2020

(54) FRICTIONALLY LOCKING SHAFT/HUB CONNECTION

(71) Applicant: RINGSPANN GmbH, Bad Homburg (DE)

(72) Inventor: Franz Eisele, Usingen (DE)

(73) Assignee: RINGSPANN GmbH, Bad Homburg (DE)

(21) Appl. No.: 16/502,664

(22) Filed: Jul. 3, 2019

(30) Foreign Application Priority Data
Jul. 5, 2018 (DE) 102018116294.4

(51) Int. Cl. F16D 1/092

(52) U.S. Cl. CPC F16D 1/092

(57) ABSTRACT

A frictionally locking shaft/hub clamping connection (1) having at least two cone clamping rings (4, 5) which bear against one another on their cone faces (4a, 5a) and can be pushed onto one another axially by way of clamping elements (6), the radial forces which are produced bringing about a frictionally locking connection between the shaft (2) and the hub (3). The cone faces (4a, 5a) of the clamping rings (4, 5) which bear against one another have a non-round cross section which differs from the circular shape.

### INCORPORATION BY REFERENCE

The following documents are incorporated herein by reference as if fully set forth: German Patent application No. 10 2018 116 294.4, filed Jul. 5, 2018.

### BACKGROUND

The invention relates to a component for a frictionally locking shaft/hub clamping connection having at least two cone clamping rings which bear against one another on their cone faces and can be pushed onto one another axially by way of a plurality of circumferentially distributed clamping elements, the radial forces which are produced bringing about a frictionally locking connection, in particular in the circumferential direction, between the shaft and the hub.

Frictionally locking shaft/hub connections of this type are standardized machine elements for connecting shafts and hubs. They can transmit torques, axial forces, transverse forces and bending moments. Their advantages in comparison with positively locking shaft/hub connections, for instance using a feather key or a splined joint, consist, above all, in that the connection is play-free, in that no or at any rate a low stress concentration is produced, in that not only relatively high torques can be transmitted, but rather also axial forces, and in that compact overall designs can be achieved by way of the high performance density.

Most cone clamping rings are arranged in an annular gap between the shaft and the hub. Instead, in the case of thin-walled hubs, however, they can also be positioned on their outer circumference. In the case of thin-walled hollow shafts, they can likewise be installed within the latter. In both cases, the cone faces which are pulled apart by way of axial clamping elements generate radial forces which bring about a frictionally locking clamping connection between the shaft and the hub.

In order to release said connections, one of the cone clamping rings is provided with a plurality of threaded bores which are distributed over the circumference and into which forcing screws can be screwed. These forcing screws press with their screwed-in end against the other cone clamping ring and release the pressed connection between the two clamping rings as a result.

The torque which can be transmitted is essentially dependent on the clamping force, by way of which the clamping elements press the cone clamping rings onto one another and wedge them; moreover, it is dependent on the cone angle and on the coefficient of friction.

If the ratios between the cone faces of the cone clamping rings, via which the torque has to be transmitted, are considered, conflicting requirements can be seen; although an increase in the coefficient of friction leads firstly to an increase in the torque which can be transmitted, a lower coefficient of friction is to be aimed for on the other hand in order to generate as high a pressing action as possible.

This results in the finding that the friction in the radial direction should be as great as possible and, in contrast, the friction in the axial direction should be as small as possible.

### SUMMARY

Based on said considerations, the present invention is based on the object of improving the known frictionally locking shaft/hub clamping connections with regard to their torque which can be transmitted, without an increased axial bracing of the cone clamping rings relative to one another being required. Here, the clamping connection according to the invention is to be distinguished by a compact and inexpensive construction.

According to the invention, said object is achieved by virtue of the fact that those cone faces of the clamping rings which bear against one another have a cross section which is non-round or is produced in a non-round manner and differs from the circular shape.

The non-round cross section of the cone faces results in a positively locking connection between the cone faces, and the transmission of torque does not only take place by way of friction (as up to now), but rather also by way of a positively locking connection. Here, depending on the extent to which the cone faces are of non-round design, the positively locking transmission of force can predominate clearly.

As a result, the transmission of considerably higher torques than up to now can be brought about by way of the design according to the invention of the cone faces, without it being necessary for the axial bracing of the cone faces to be increased to this end.

Different possibilities are offered to a person skilled in the art for the configuration of the non-round cone faces. It is to be noted here merely that the cone faces should run without notches or edges, for instance by being approximated to a mathematically constant curve progression.

In the simplest case, the cone faces can have an oval or elliptical cross section. In order to boost the positively locking connection, however, it is recommended that they have a polygonal or cycloidal cross section, in particular with at least three projections in the one cone clamping ring which are of weak configuration and are distributed over the circumference, and with recesses in the other cone clamping ring which correspond with said projections.

These projections and recesses should have a diameter difference relative to one another of from approximately 5% to approximately 30%, preferably of from approximately 8% to approximately 20%. This results in merely low angular deviations of the contour from the circular contour, and the projections and recesses which follow one another can merge into one another without abrupt contour changes.

The projections and recesses are expediently connected to one another by way of arcuate or approximately tangentially running circumferential sections. It is recommended here to configure the arcuate or approximately tangentially running circumferential sections to be longer than the projections or recesses, in particular at least 50% longer, preferably at least 80% longer.

A greater radial overall height of the clamping rings results in the region of the approximately tangentially running circumferential sections. It is therefore recommended to position the axial clamping elements, for example clamping screws, offset radially with respect to the center of the approximately tangentially running circumferential sections, with the result that the structural free space which is present there is utilized.

One particular advantage of the component according to the invention is that the cone faces can be provided with a coating which reduces the coefficient of friction and/or a lubricant which reduces the coefficient of friction. The cone faces are preferably treated with a lubricant on the basis of molybdenum(IV) sulfide (MoS) or with MoS2 additives such as grease which is fortified with MoS2. As a result, improved axial bracing is achieved which leads to a substantially higher transmission of torque between the shaft and the hub. Measures of this type which reduce the coefficient of friction are impermissible in the case of conventional cone clamping elements, since they would lead to slipping of the cone faces in the rotational direction. This disadvantage is overcome by way of the positively locking transmission of force between the cone faces of the clamping rings. In contrast, in order to achieve the best possible frictionally locking connection, the cylindrical faces of circular profile on the inside toward the shaft and on the outside toward the hub of the cone clamping element can be joined in a dry manner. The use of lubricant which reduces the coefficient of friction on the cone faces and dry joining on the cylindrical outer faces and inner faces makes a reduction of the required tightening moments possible, with a higher transmission of torque at the same time. Moreover, the number of clamping elements (clamping screws) can be reduced in comparison with conventional cone clamping elements, which shortens the assembly time.

A further modification of the invention can include that the cone faces do not have a non-round profile over the entire axial extent, but rather have a first section with a circular profile which merges constantly in the direction of the center axis of the cone clamping rings into a second section with a non-round profile. For example, in its smaller diameter region, the cone can have a circular cross section which merges in the direction of the conically increasing diameter into a non-round profile. A configuration of this type can have advantages, in particular, in the case of slotted cone clamping rings with regard to the distribution of the pressing forces.

### BRIEF DESCRIPTION OF THE DRAWINGS

Further features and advantages result from the description of one exemplary embodiment and from the drawing, in which:

FIG. 1 shows a longitudinal section through the clamping connection according to the invention in the installed state between a shaft and a hub,

FIG. 2 shows an axial plan view of an inner cone clamping ring,’

FIG. 3 shows an axial plan view of an outer cone clamping ring, and

FIG. 4 shows a perspective view of the two cone clamping rings in the state in which they are not yet installed.

### DETAILED DESCRIPTION

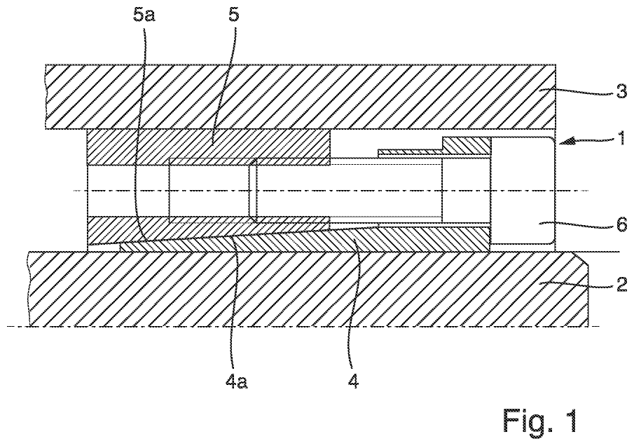

The axial section in FIG. 1 shows a releasable shaft/hub clamping connection 1 which is installed and braced between a shaft 2 and a hub 3.

The shaft/hub connection is formed of an inner cone clamping ring 4 which is seated on the shaft 2, an outer cone clamping ring 5 which carries the hub 3 on the outside, and of a plurality of axial clamping elements which are distributed over the circumference in the form of screws 6.

The cone clamping rings 4 and 5 bear against one another along the cone faces 4a and 5a, and can be displaced and braced relative to one another by way of the screws 6.

To this end, the screws 6 lie with their screw head against the end side of the inner cone clamping ring 4, pass through the latter and are screwed with their threaded shank into corresponding threaded bores of the outer cone clamping ring 5.

The two cone clamping rings 4 and 5 are pushed onto one another by way of the tightening of the screws 6. Here, the cone faces 4a and 5a which bear against one another bring about radial widening of the clamping rings, with the result that a clamping connection is produced between the shaft 2 and the hub 3.

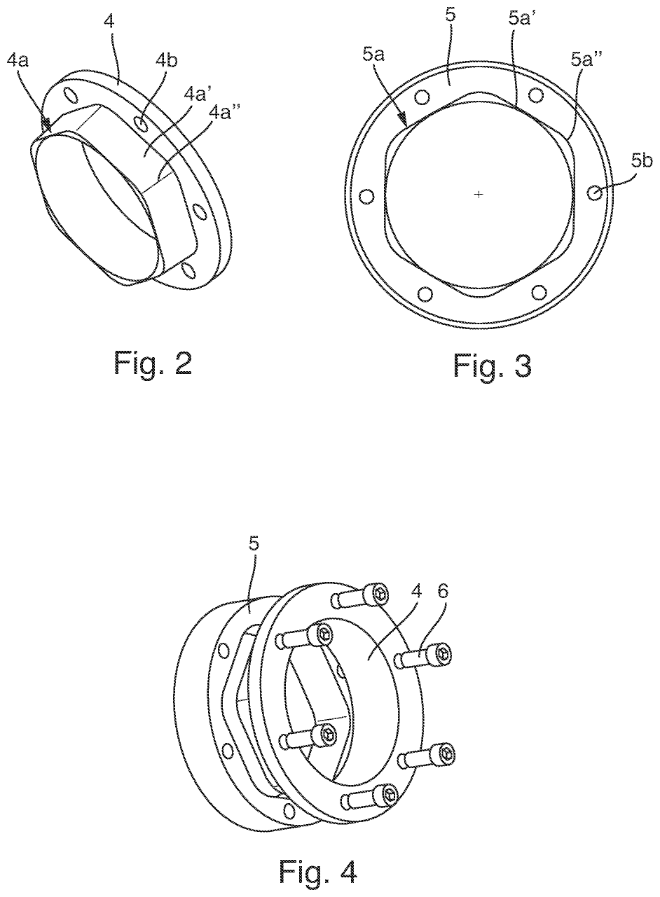

It is essential then that, in accordance with FIGS. 2 and 3, the two cone clamping rings 4 and 5 have non-round cone faces 4a and 5a, respectively. The cone faces 4a and 5a have already been configured in a manner which corresponds to one another during the production, with the result that they come into flat contact with one another when the cone clamping rings are plugged together, and, during the tightening of the clamping screws 6, bring about not only the desired radial widening of the clamping connection radially to the inside and radially to the outside, but rather also enter into a positively locking connection.

In the exemplary embodiment, the cone faces 4a and 5a consist of approximately tangentially running circumferential sections 4a′ and 5a′, respectively, which are connected to one another at their ends by way of arcuate sections 4a″ and 5a″, respectively. Here, the arcuate sections 4a″ act as projections, and the arcuate sections 5a″ act as recesses.

The approximately tangential circumferential sections 4a′ and 5a′ are more than twice as long as the arcuate circumferential sections 4a″ and 5a″, respectively.

In the exemplary embodiment, the cone faces consist in each case of six tangential and six arcuate circumferential sections. It goes without saying that it lies within the scope of the invention to decrease or to increase the number of said circumferential sections. It is merely to be ensured here that the cone faces run without abrupt changes of the contour, in particular without points or notches.

FIG. 4 shows the two clamping rings 4 and 5 and the clamping screws 6 in the state in which they are not yet mounted. Here, the clamping screws 6 cross through the inner cone clamping ring 4 on its radially projecting flange as is customary, but they are not yet screwed into the outer cone clamping ring 5.

As soon as the cone clamping rings 4 and 5 are moved together axially and are braced sufficiently by way of the clamping screws 6, they are connected to one another not only in a frictionally locking manner as previously, but rather also in a positively locking manner on account of the non-round clamping face contour.

As a result, the torque which can be transmitted is increased considerably in comparison with conventional frictionally locking shaft/hub clamping connections.

Conventional cone clamping elements are usually slotted in each case once both on the inner ring and on the outer ring, in order that the bridging of the play, for example from IT8 to IT7, takes place without an appreciable pressure loss. It is likewise possible within the context of the present invention for the cone clamping rings, that is to say the inner ring and the outer ring, to be of slotted configuration. During clamping of the cone clamping rings, a certain relative movement of the inner cone face with respect to the outer cone face in the circumferential direction takes place on account of the slotting. This leads to those contours of the corresponding cone faces of the inner cone ring and the outer cone ring which differ from the circular shape no longer fitting together in an optimum manner in the case of said relative movement. Therefore, a slight plastic deformation of the cone clamping rings can take place during clamping, which plastic deformation is accepted, however. As an alternative, it is possible for the cone clamping rings to be of non-slotted configuration. In this case, the permissible fits are to be correspondingly restricted, for example IT7 to IT6.

1. A component for a frictionally locking shaft/hub clamping connection (1), comprising:
at least two cone clamping rings (4, 5) which bear against one another on cone faces (4a, 5a) thereof that are adapted to be pushed onto one another axially by way of a plurality of circumferentially distributed clamping elements (6), such that radial forces are produced to bring about a frictionally locking connection in a circumferential direction between the shaft (2) and the hub (3), and the cone faces (4a, 5a) of the clamping rings (4, 5) which bear against one another have a non-round cross section that differs from a circular shape.

2. The component as claimed in claim 1, wherein the cone faces (4a, 5a) have a mathematically constant curve progression.

3. The component as claimed in claim 1, wherein the cone faces (4a, 5a) have an oval cross section.

4. The component as claimed in claim 1, wherein the cone faces (4a, 5a) have a polygonal or cycloidal cross section.

5. The component as claimed in claim 1, wherein the cone faces (4a, 5a) have at least three projections (4a″, 5a″) or recesses which are distributed uniformly over circumferences thereof, correspond with one another, and are connected to one another by way of arcuate or approximately tangentially running circumferential sections (4a′, 5a′) which correspond with one another.

6. The component as claimed in claim 5, wherein the projections (4a″, 5a″) or the recesses and the approximately tangentially running circumferential sections (4a′, 5a′) have a diameter difference relative to one another of from approximately 5% to approximately 30%.

7. The component as claimed in claim 5, wherein the approximately tangentially running circumferential sections (4a′, 5a′) are longer in the circumferential direction than the projections (4a″, 5a″) or the recesses.

8. The component as claimed in claim 6, wherein the approximately tangentially running circumferential sections (4a′, 5a′) are at least 50% longer than the projections (4a″, 5a″) or the recesses

9. The component as claimed in claim 1, wherein the cone faces are provided with at least one of a coating which reduces a coefficient of friction or a lubricant which reduces the coefficient of friction.

10. The component as claimed in claim 1, wherein the cone clamping rings (4, 5) have bores (4b, 5b) for the clamping elements (6), said bores (4b, 5b) extend axially and are distributed over a circumference, and said bores are positioned in circumferential regions of a maximum radial wall thickness of the cone clamping rings.

11. The component as claimed in claim 1, wherein the axial clamping elements (6) are positioned offset radially with respect to a center of the approximately tangentially running circumferential sections (4a′, 5a′).

12. The component as claimed in claim 1, wherein the cone faces (4a, 5a) which bear against one another have a constantly changing cross-sectional profile in an axial direction, said cross-sectional profile merges from a first cone region with a circular cross section into a region of a second cone region with a non-round cross section.
